(19) United States
(12) Patent Application Publication
(10) Pub. No.: US 2012/0112577 A1
(43) Pub. Date: May 10, 2012

(54) ELEVATOR MACHINE WITH EXTERNAL ROTOR AND MOTOR WITHIN TRACTION SHEAVE

(75) Inventors: Zlatko Strbuncelj, Avon, CT (US); James L. Hubbard, Kensington, CT (US); Martin J. Hardesty, West Hartford, CT (US)

(73) Assignee: OTIS ELEVATOR COMPANY, Farmington, CT (US)

(21) Appl. No.: 13/382,129

(22) PCT Filed: Jul. 10, 2009
(86) PCT No.: PCT/US2009/050238

§ 371 Date: Jan. 3, 2012

(51) Int. Cl. H02K 9/04

(52) U.S. Cl. 310/63

(57) ABSTRACT

A drive machine (10) for elevators has a rotatable drive sheave (18) that has an inner surface and an outer surface with at least one groove (34) for receiving a hoist rope. A rotor (36) is attached to the inner surface of the sheave (18). A stator (38) is connected to a fixed hollow shaft (22), wherein the stator (38), rotor (36), and drive sheave (18) are concentrically positioned about a centerline of the fixed hollow shaft (22). A plurality of bearings (42) are placed between the shaft (22) and rotor (36).

### BACKGROUND

The present disclosure relates to elevator drive machines. More specifically, the disclosure relates to elevator drive machines with a rotor attached to a sheave of the drive machine.

A typical traction elevator system includes a car and a counterweight disposed in a hoistway, a plurality of ropes that interconnect the car and counterweight, and a machine having a traction sheave engaged with the ropes. The drive machine of the traction elevator has a traction sheave with grooves for the hoisting ropes of the elevator and an electric motor driving the traction sheave either directly or through a transmission. The ropes are driven by rotation of the traction sheave that results in repositioning of the car and counterweight within the hoistway. The traction machine, and its associated electronic equipment, along with peripheral elevator components, such as a governor and safety features, are housed in a machine room located adjacent the hoistway. Conventional traction machines make use of alternating current (AC) permanent magnet hoist motors, which have permanent magnets in the rotor in order to improve the efficiency of the machine. The conventional machines, however, are limited to relatively low duty cycles and low speeds.

The physical dimensions of an elevator drive machine affect the size of the elevator shaft and/or the building itself, depending on where the machine is located. When the machine is placed in or beside the elevator shaft or in a machine room, the size of the machine has an importance with respect to the space required. One of the problems encountered in gearless elevator machines of conventional construction has been their large size and weight. Such motors take up considerable space and are difficult to transport to the site and to install. In large elevator machines, transmitting the torque from the drive motor to the traction sheave can be a problem. These types of machines are large in size, and asymmetrical. This imposes special requirements on the electric drive of the motor to allow full-scale utilization of the motor, and the size of the motor becomes unwieldy. Specialized equipment and large cranes are required for getting such motors in place during construction of structures. Further, the size of the motors and machines and area required might be greater than that of the cross-sectional area of the hoistway of the elevator, again requiring specialized mounting arrangements. Special requirements generally result in a complicated system or a high price, or both.

Thus there is a need in the art to develop elevator systems that efficiently utilize the available space and meet the duty load and speed requirements over a broad range of elevator applications. Further, there exists a need to have a machine which operates reliably and which is compact, in particular in order to make it easier to install in an elevator shaft. There also exists a need for a machine that is relatively easy to manufacture and versatile in design.

### SUMMARY

In one aspect, a drive machine for elevators has a rotatable drive sheave that has an inner surface and an outer surface for receiving a hoist rope. A rotor is attached to the inner surface of the sheave. A stator is connected to a fixed hollow shaft, wherein the sheave and rotor are positioned to rotate about a centerline of the fixed hollow shaft. A plurality of bearings are placed between the shaft and rotor.

In another aspect, a drive machine for an elevator has a machine frame and a cylinder having a first side, a second side, an inner diameter and an outer diameter with the outer diameter forming a sheave. The machine also has a rotor attached to the inner diameter of the cylinder, a first support structure and second support structure that are attached to the machine frame, and a hollow shaft attached at a first end to the first support structure and at a second end to the second support structure. A stator is attached to the hollow shaft. The cylinder is connected to the shaft through first and second bearings at each respective side of the cylinder, resulting in a motor contained within the cylinder.

In another aspect, a drive machine for an elevator has a cylinder having a first side, a second side, an inner diameter and an outer diameter with the outer diameter forming a sheave. The machine also has a rotor attached to the inner diameter of the cylinder. A first support structure and second support structure are attached to a hollow shaft. A stator is also attached to the hollow shaft, and a first bearing and a second bearing are connected to each respective side of the cylinder to mount the cylinder to the shaft. Each bearing has a stationary inner race attached to the hollow shaft and a rotating outer race secured to each respective side of the cylinder.

### BRIEF DESCRIPTION OF THE DRAWINGS

FIG. 1 is a perspective view of a drive machine for an elevator.

FIG. 2 is a sectional perspective view of a drive machine for an elevator.

FIG. 3 is a cross-sectional elevation view of a drive machine for an elevator.

FIG. 4 is a cross-sectional view of a drive machine for an elevator illustrating cooling air flow through the motor.

### DETAILED DESCRIPTION

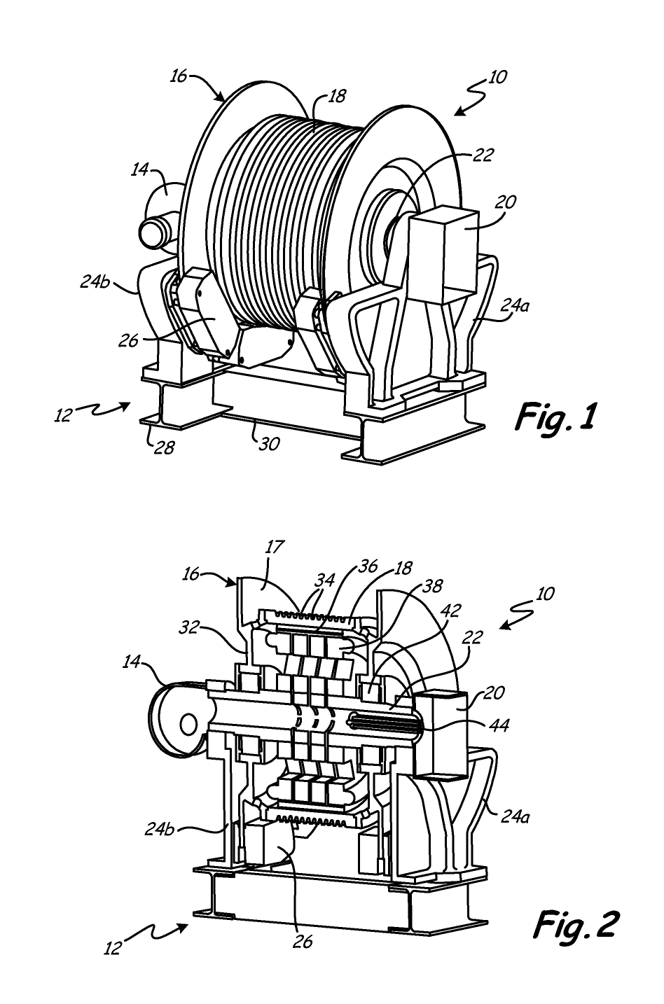

FIG. 1 is a perspective view of drive machine 10 on frame 12 for an elevator. Drive machine 10 includes cooling system 14, cylinder 16 with sheave 18, electrical box 20, shaft 22, supports 24a and 24b, and brake system 26. Supports 24a and 24b provide a structure for mounting shaft 22. Cylinder 16 and sheave 18 are designed to rotate about a central axis of shaft 22. Cylinder 16 is attached to sheave 18. Alternatively, cylinder 16 and sheave 18 are a singular structure. Sheave 18 contains grooves for ropes or cables that attach to the elevator car and/or counterweight. Cylinder 16 and sheave 18 are constructed from metals, alloys, and similar materials.

Supports 24a and 24b also provide structure for mounting of cooling system 14 and electrical box 20. Brake system 26 is attached to outer cylinder 16, and may also be attached to supports 24a and 24b. Electrical box 20 may be a NEMA or galvanized steel box, and contains the electrical connections, terminals, and controls for drive machine 10. Electrical wires (not shown) will run from electrical box 20 and connect to a power source to provide the electrical power to run drive machine 10. Cooling system 14 includes a fluid moving device attached to fluid directing structures, and acts to lower the temperature of the drive machine 10.

Braking system 26 is mounted adjacent to cylinder 16, and may also have components attached to supports 24a and 24b. Braking system 26 engages cylinder 16 to slow or stop the rotation of cylinder 16 about shaft 22.

Frame 12 is fabricated from structural supports 28 and 30. As illustrated, two structural supports 28 are generally parallel to one another, and are attached to the bottom surfaces of supports 24a and 24b. Structural support 30 is a cross piece to provide additional structural integrity to frame 12. Frame 12 elevates drive machine 10 from a surface (for example, the floor of a machine room in a building), and assures that cylinder 16 can freely rotate about shaft 22.

FIG. 2 is a sectional perspective view of drive machine 10 on frame 12. Drive machine 10 includes cooling system 14, outer cylinder 16 with sheave 18, electrical box 20, supports 24a and 24b, and brake system 26, which have been previously described. In this view, cylinder 16 has centrally located side portions 32 and outer disc 17 extending therefrom. Side portions and outer disc 17 may be fabricated a single part, or may be separate parts joined together. Outer disc 17 may be steel, cast iron, or similar materials. Brake system 26 receives outer disc 17. When a friction force is applied to outer disc 17, cylinder 16 will slow or stop turning, and thus outer disc 17 acts as a brake disc. Side portions 32 are at each end of cylinder 16, and act as a motor endbell.

Side portions 32 also provide support for sheave 18. Sheave 18 contains a series of grooves 34 that receive the ropes of the elevator system. Sheave 18 may be constructed from cast iron. Rotor 36 is attached to the radially inner side of sheave 18 opposite grooves 34. Rotor 36 and sheave 18 are secured together so that the pieces may rotate about the central axis of shaft 22. Rotor 36 is a disc with permanent magnets attached to the disc by any suitable method. The permanent magnets may be of different shapes and may be divided into component magnets situated radially side by side, or one after another in an axial direction. Rotor 36 may also include a field iron core between the magnets and sheave 18.

Directly adjacent and coaxially located within rotor 36 is stator 38. Rotor 36 and stator 38 form a motor that causes sheave 18 to rotate. Stator 38 is a winding of metallic wire, and may be a slot winding that creates the armature for the motor of drive machine 10. Stator is affixed to shaft 22. Shaft 22 is a hollow tube with a central axis, is fabricated from a metal. The hollow tube of shaft 22 allows shaft 22 to act as a fluid flow path for cooling system 14, as well as a housing for wiring harness 44. Wiring harness 44 is the electrical lead wires from the stator to electrical box 20. A first end of shaft 22 terminates adjacent electrical box 20, while a second end of shaft 22 terminates adjacent a blower housing of cooling system 14.

Shaft 22 is supported at both ends by supports 24a and 24b. As illustrated in FIGS. 1 and 2, supports 24a and 24b may be mirror replications of each other. Supports 24a and 24b are illustrated as containing a central “A” with side braces extending from the horizontal line that extend down to the lower surface adjacent the angled legs, although in other embodiments the supports 24a and 24b can be of varying geometries.

Cylinder 16 creates a motor housing for rotor 36 and stator 38, which in turn create a motor for drive machine 10. Cylinder 16, sheave 18, and rotor 36 comprise the rotating part of drive machine 10. This rotating assembly is rotatably mounted on stationary shaft 22 through bearings 42. Supports 24a and 24b position shaft 22 so that the rotating assembly can turn freely without interference from the mounting surface. Alternately, frame 12 can be positioned below supports 24a and 24b and add additional distance between shaft 22 and the mounting surface on which drive machine 10 is secured.

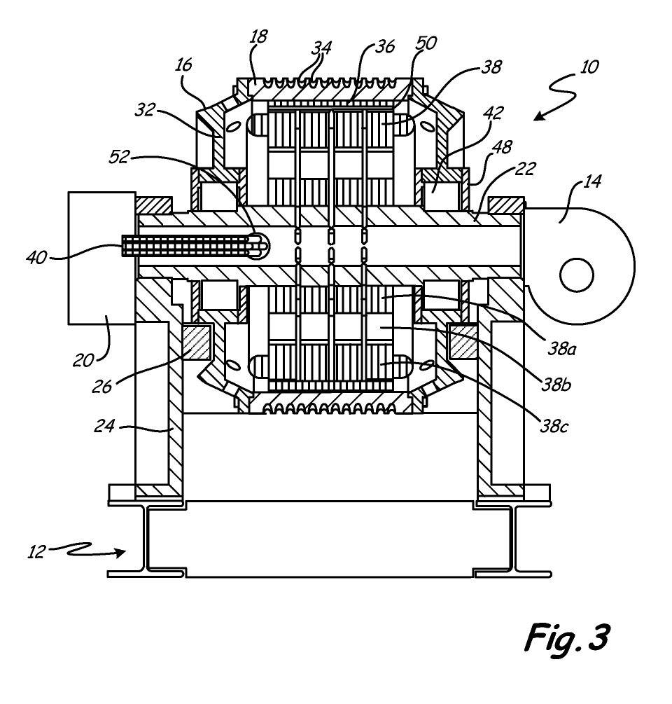

FIG. 3 is a cross-sectional elevation view of another aspect for drive machine 10 for an elevator. Again, drive machine 10 includes cooling system 14, outer cylinder 16 with sheave 18, electrical box 20, supports 24a and 24b, and brake system 26. In this embodiment, cylinder 16 contains side portions 32, provide support for sheave 18. Side portions 32 act as a casing for the motor components, including rotor 36 and stator 38. Brake system 26 has been moved due to the absence of a brake disc extending radially outward from side portions 32, but still will provide friction to slow or stop cylinder 16 from rotating when applied. Side portion 32 of cylinder 16 is attached to bearing holder 48, which assures that the rotating assembly of the motor is maintained in the required location with respect to shaft 22.

Stator 38 includes an iron core fixed to shaft 22 and has several discrete windings represented by winding areas 38a and 38c. The windings contain a hollow central area represented by area 38b. This arrangement of coil windings reduces the mass of the motor, and thus drive machine 10. Alternatively, area 38b contains a filler material, or is an iron core. Lead wires 40 extend from electrical box 20, through the hollow shaft 22, and exit at aperture 52 where they are connected to the windings of stator 38.

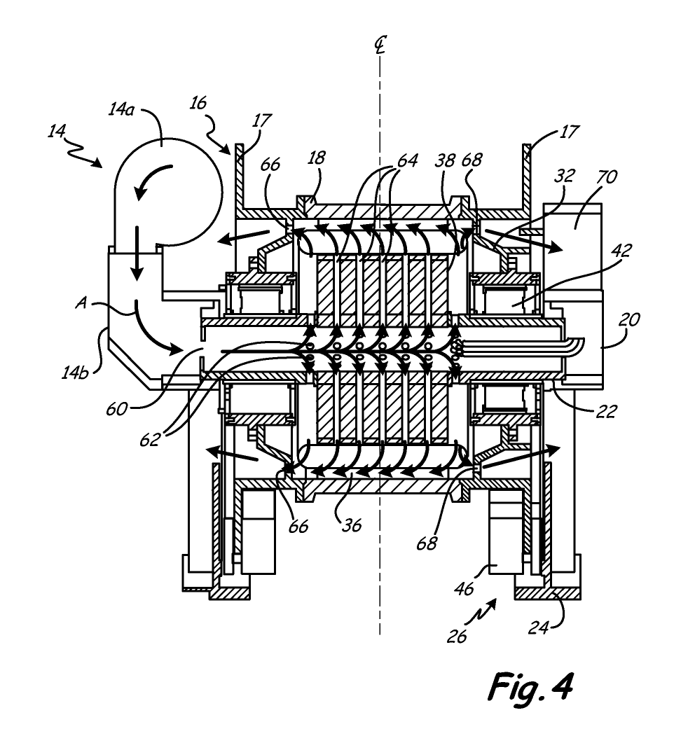

FIG. 4 is a cross-sectional view illustrating the cooling of drive machine 10. Cylinder 16 with sheave 18, cooling system 14, electrical box 20, and braking system 26 are shown in FIG. 4. Cooling system 14 includes blower 14a connected to duct 14b, which is connected to the hollow shaft 22. Air flow represent by arrow A is created by blower 14a of cooling system 14. As illustrated, air flow A enters shaft 22 at inlet aperture 60. Shaft 22 contains a plurality of circumferentially and axially spaced outlet apertures (over vent holes) 62, through which the air flow A continues on a radial outward path through stator 38. In this embodiment, stator 38 has a series of laminations separated by gaps 64. A stator with a stack of magnetic laminations limits loss due to induction currents. Apertures 62 align with gaps 64 in the coil windings of stator 38. The air flow continues through gap 50 between stator 38 and rotor 36, and exits through apertures 66 and 68 within side portions 32 of cylinder 16. Heat produced during operation of drive machine 10 must be removed. Air flow A cools the components of drive machine 10 to prevent high operating temperature, which can affect performance or damage the motor and other components of drive machine 10.

Cylinder 16 of drive machine 10 contains outer disc 17. In this embodiment, outer disc 17 is a brake disc, and is connected to sheave 18. Braking system 26 contains brake calipers 46 that engage outer disc 17, which are common in the art. These are connected to the elevator control system (not illustrated) to slow or hold in place drive machine 10. Outer disc 17 may be fabricated as a single part with sheave 18. Alternatively, outer disc 17 and side support 32 are constructed as single part, or outer disc 17, side support 32, and sheave 18 may all be separately fabricated and later attached joined together. Rotor 36 is mounted to shaft 22 through bearing 42. Bearing 42 contains a stationary inner race secured to shaft 22, and rotating outer race attached to side support 32.

Drive machine 10 may also contain locating system 70. Locating system 70 will measure or detect the speed and relative position of the magnetic fields of stator and rotor 36, and acts a position feedback device. This information is then passed along to the elevator control system and is used to control hoist motor operation, which is in turn used to locate elevator cars within a hoistway that are attached to drive machine 10. In one aspect, locating system 70 may include a ring that acts an absolute value encoder. The encoder ring surrounds a projected flange on cylinder 16, and is joined to the flange through a bearing, which is common in the art. Another portion of the encoder is secured to shaft 22. The encoder detects the position of the permanent field magnet of rotor 36, and the phases of currents supplied to the armature windings of stator 38 are controlled by the elevator control system based on the detected position. Locating system 70 can detect the speed and rotating distance of sheave 18 traveling in either clockwise or counterclockwise directions. Alternatively, locating system may include an optical sensor or mechanical sensor, such as a pulley that contacts rotor 36.

Cylinder 16 with sheave 18 and side supports 32, as well as rotor 36 and stator 38 may be symmetrical about a centerline CL. Cylinder 16 with sheave 18 and rotor 38 is coaxially aligned and concentric with respect to shaft 22 and stator 36. The location of the rotor 36 on the inner diameter of sheave 18 permits symmetry of the motor and sheave 18 of drive machine 10. The symmetry of the motor of drive machine 10 allows for smoother operation and reduces vibration in the elevator system, as well as reduces the length and size of drive machine 10.

Shaft 22 is a hollow structure. Stator 38 is attached to shaft 22, and the assembly is stationary. Thus, shaft 22 does not experience the stress associated with a moving shaft. This allows shaft 22 to be a lighter structure as shaft 22 experiences negligible fatigue loading. Conventional rotating shafts are typically constructed from steel that has a known fatigue and stress rating. Hollow shaft 22 can be constructed from a wider variety of materials. Shaft 22 may be cast, and contain vent holes 62 illustrated in FIG. 4. In addition, a cast shaft 22 can contain numerous features that benefit motor and drive machine 10 operation. Shaft 22 can also be machined to include critical features. For example, shaft 22 in FIGS. 1 and 2 contains the greatest wall thickness adjacent stator 36, has machined areas for bearing lands to position bearings 42, and contains a thinner wall thickness that may taper for mounting shaft 22 to supports 24. Further, with stationary shaft 22 and bearing 42 having a stationary inner race, lead wires could be run along a slot fabricated in shaft 22 directly beneath the inner race of one bearing 42.

Also, with an external rotor motor design, the motor has a lower mass compared to conventional internal rotor motors. The smaller motor design results in external rotor 36 having a larger air gap diameter, which leads to a shorter motor length for the same torque output of the motor. The motor is inside and concentric with sheave 18, rather than adjacent the sheave with conventional machines. The smaller size and symmetry of the motor means machine room layout is easier and more versatile. Further, with a symmetrical machine, bearing loads are evenly distributed between bearings 42, which benefits the design of drive machine 10. The reduced size and mass of the motor results in lower cost of drive machine 10.

Although the present invention has been described with reference to preferred embodiments, workers skilled in the art will recognize that changes may be made in form and detail without departing from the spirit and scope of the invention.

1. A drive machine for elevators comprising:
a rotatable drive sheave having an inner surface and an outer surface with at least one groove for receiving a hoist rope;
a rotor attached to the inner surface of the sheave;
a fixed hollow shaft;
an air cooling system comprising a blower connected to a first end of the fixed hollow shaft;
a stator connected to the fixed hollow shaft, wherein the stator, the rotor, and the sheave are positioned concentrically about a centerline of the fixed hollow shaft;
a plurality of bearings between the shaft and rotor.

2. The drive machine of claim 1 further comprising:
a braking mechanism mounted adjacent the sheave.

3. The drive machine of claim 1 wherein the rotor comprises permanent magnets.

4. The drive machine of claim 1 further comprising:
a power control box; and
lead wires extending from the stator to the power control box through the fixed hollow shaft.

5. The drive machine of claim 1 wherein the stator comprises stator windings with a plurality of laminations, with each lamination separated from adjacent laminations to form a plurality of gaps.

6. The drive machine of claim 5
wherein the fixed hollow shaft contains a plurality of outlet apertures that align with the gaps to create a path for airflight from the blower through the shaft and into the stator.

7. A drive machine for elevators comprising:
a machine frame;
a cylinder having a first side, a second side, an inner surface and an outer surface, wherein the outer surface forms a sheave;
a rotor attached to the inner surface of the cylinder;
a first support structure and second support structure attached to the machine frame;
an air circulating system attached to the first support structure;
a hollow shaft attached at a first end to the first support structure and at a second end to the second support structure; and
a stator attached to the hollow shaft and concentrically positioned within the rotor;
wherein the cylinder is rotatably and concentrically positioned within the rotor connected to the shaft through first and second bearings at each respective side of the cylinder; and
wherein the stator and rotor comprise a motor contained within the cylinder.

8. The drive machine of claim 7 further comprising:
a position feedback device mounted to the hollow shaft.

9. The drive machine of claim 7 wherein the hollow shaft provides a housing for a portion of a wiring assembly connecting the stator to a power source.

10. (canceled)

11. The drive machine of claim 10 wherein the air circulating system has a blower connected to the hollow shaft, and wherein the hollow shaft and the first and second sides of the cylinder contain a plurality of apertures to create flowpaths for circulation of air from the blower within the drive machine.

12. The drive machine of claim 11 wherein the stator contains a plurality of gaps between a plurality of coils that define the fluid flowpaths within the drive machine.

13. The drive machine of claim 7 further comprising:
a braking disc attached to at least one of the first and second sides of the cylinder.

14. The drive machine of claim 13 further comprising:
a braking mechanism positioned adjacent to at least one braking disc.

15. The drive machine of claim 7 wherein the first and second bearings contain an outer rotating race and a stationary inner race.

16. A drive machine for an elevator comprising:
a cylinder having a first side, a second side, an inner surface and an outer surface, wherein the outer surface forms a sheave;
a rotor attached to the inner surface of the cylinder;
a first support structure and a second support structure;
a hollow shaft attached at a first end to the first support structure and at a second end to the second support structure, wherein the shaft contains a plurality of apertures in a wall of the shaft;
a stator attached to the hollow shaft and concentrically positioned within the cylinder and the rotor; and
a first bearing and a second bearing connected to each respective side of the cylinder, each bearing having a stationary inner race attached to the hollow shaft and a rotating outer race secured to each respective side of the cylinder.

17. The drive machine of claim 17 wherein the hollow shaft contains varying wall thicknesses along a length of the shaft, with wall thickness being greatest adjacent the stator.

18. The drive machine of claim 18 wherein the hollow shaft contains two bearing lands fabricated adjacent the greatest wall thickness.

19. (canceled)

20. Air circulation system connected to the hollow shaft for supplying air to be delivered to the stator through the apertures in the wall of the shaft.
